(19) United States
(12) Patent Application Publication
(10) Pub. No.: US 2021/0276768 A1
(43) Pub. Date: Sep. 9, 2021

(54) Reusable Lid and Carrying Case

(71) Applicant: Ashley Ziegler, San Francisco, CA (US)

(72) Inventor: Ashley Ziegler, San Francisco, CA (US)

(21) Appl. No.: 17/191,285

(22) Filed: Mar. 3, 2021

Related U.S. Application Data
(60) Provisional application No. 62/985,037, filed on Mar. 4, 2020.

(51) Int. Cl. B65D 47/08; A47G 19/22; A45C 13/30

(52) U.S. Cl. CPC B65D 47/0857; A47G 19/2272; A45C 2200/20; B65D 2543/00046; A45C 2013/306; A45C 13/30

(57) ABSTRACT

A reusable lid and carrying case are described in which the reusable lid can be attached to cover disposable beverage cups. The reusable lid and carrying case are tools to help prevent overconsumption of single use plastic lids that are given to customers with to-go cups and beverages bought at a variety of venues and to minimize pollution to the environment. The reusable lid includes an upper platform with a drink opening and drink cover that can selectively be opened and closed over the drink opening and includes an outer rim, which is configured to grip the top rim of a disposable cup. The lower platform of the reusable lid includes an interior wall that extends all around the lower platform and is configured to fit within the disposable cup in order to provide a secure fit when the reusable lid is covering a top opening of the disposable cup.

### CROSS-REFERENCE TO RELATED APPLCATIONS

This application is a non-provisional application which claims priority to U.S. Provisional Patent Application No. 62/985,037 filed on Mar. 4, 2020, which is incorporated by reference in its entirety.

### FIELD OF THE DISCLOSURE

The present invention relates to a reusable lid for use in covering disposable beverage cups as well as embodiments for an accompanying carrying case.

### BACKGROUND

There is a growing awareness of the impact that manmade goods have on the environment, and this impact is becoming of paramount concern all around the world. This is especially true because countries around the world are experiencing unprecedented weather-related events, such as devastating storms, tornadoes, hurricanes, drought, and fires without warning and with limited means to respond to these natural disasters. Further, countries around the world are trying to combat global warming and the issues related to global warming affecting the future of planet earth. One of the main issues that has been identified is the overuse of plastic by humans. It is known that it takes hundreds to thousands of years for plastic to fully disintegrate and disappear when buried in the ground. More often than not, plastic waste finds its way into water sources, such as oceans and lakes, and disrupts and disturbs the animals and wildlife living in that environment.

Plastic has been found to be particularly harmful to living organisms. Because of the excessive amount of plastic used that makes its way into our waterways and food sources, it is estimated that humans may consume approximately 44 pounds of plastic in their lifetime or on average about five grams of plastic every week. There are many reasons why plastic has to be reduced in general in society, but primarily, the environment would benefit if more efforts were made to limit waste and to reuse items as much as possible rather than disposing of plastic items after only a single use.

Plastic straws, lids, and cups are sold and used in the millions on a daily basis around the world. Coffee shops and other locations that sell beverages are frequently providing to their customers disposable single use lids to cover their beverages, and in particular, hot beverages. A recent statistic stated that based on the use of plastic lids alone in New York, the amount of waste of plastic lids used once and then thrown away could circle the Earth at least three times. This is a troubling statistic that indicates there is too much waste of single use, plastic, disposable lids.

It is noted that some coffee shops do provide non-disposable mugs that a customer may use to drink their hot beverage either in the store or to go. Further, there are non-disposable drink thermoses and other kinds of non-disposable, reusable drink containers that have varying structures. Unfortunately, it is more common that the user is provided with a disposable cup and disposable lid or chooses to use a disposable cup having a disposable, single use lid. This results in the waste of millions of single use disposable lids that end up in landfills, in water sources, or as trash littering public spaces and contribute to the environmental problems currently being experienced around the world.

While a user may be able to buy and carry a non-disposable drink container (e.g., such as those drink containers made of glass, metal, or a sturdy plastic) often times a user may forget to take such a container with him or her to their preferred drinking establishment.

Additionally, the size of the drink container may make it more cumbersome to carry around as well.

Accordingly, there is still an unsolved need for an alternative to disposable lids for beverages that may still fit the standard sized cups and containers sold by most establishments that is a reusable lid. Further, it would be beneficial and helpful to the user if the reusable lid has an accompanying portable carrying case for storing and retaining the reusable lid.

### SUMMARY

The present description includes one or more embodiments for a reusable lid and portable carrying case for containing the reusable lid. In a first embodiment, a reusable lid may be used to cover a top opening of a cup, and especially a disposable cup provided by an establishment. The reusable lid may include an upper platform, whereby the upper platform comprises a top level and a drink opening on the top level. A think cover may be included on the upper platform of the reusable lid, whereby the drink cover is configured to cover the drink opening. Further, the drink cover is configured to selectively cover and provide access to the drink opening. An outer rim that encircles the perimeter of a lower level of the upper platform may also be included on the upper platform, whereby a portion of the outer rim of the reusable lid descends downwardly. The reusable lid may further include a lower platform, whereby the lower platform comprises an interior wall located on the underside of the reusable lid, whereby the interior wall is a circular wall that is continuously formed and descends downwardly from the upper platform. The interior wall functions to fit inside of an interior of a cup and to abut the interior walls of the cup. Further, the interior wall ensures a tight fight between the reusable lid and the cup.

The present description includes an exemplary method of using a reusable lid. The method may include providing a reusable lid adapted for use to fit over a top rim and top opening of a disposable cup, whereby the disposable cup is provided by an establishment. The reusable lid may be sized and dimensioned to fit a specific size and set of dimensions associated with the disposable cup, whereby the reusable lid is reusable multiple times over an extended period of time and can cover any disposable cup having the specific size and set of dimensions that corresponds to the size of the reusable lid.

The present description may further include a system for a reusable lid and accompanying carrying case. The reusable lid may comprise an upper platform, whereby the upper platform includes a top level. The top level may include a drink opening and a circular wall. The circular wall is continuous and encircles a flat surface located beneath the top level, whereby the circular wall angles downwardly towards the flat surface. The upper platform may further include an outer rim, whereby the outer rim protrudes downwardly from the upper platform. The upper platform of the reusable lid may further include a drink cover configured to cover the drink opening, whereby the drink cover is positioned on the flat surface located beneath the top level and encircled by the continuously formed, circular wall. Further, the drink cover may be hingedly connected to the flat surface and is configured to selectively cover and provide access to the drink opening.

The reusable lid may further include a lower platform, whereby the lower platform comprise an interior wall located on the underside of the upper platform. The interior wall may be a circular wall that is continuously formed and descends downwardly from an underside of the upper platform, whereby the reusable lid is configured to be positioned over a top rim of a cup. The outer rim of the upper platform fits over the top rim of the cup, and the interior wall of the reusable lid fits within an interior of the cup, whereby the interior wall acts to provide a tight fit between the reusable lid and the cup.

The system may further include a carrying case, whereby the carrying case is configured to contain the reusable lid. The carrying case may further include a lid and a base, whereby the reusable lid is configured to fit within an interior space of the carrying case.

Other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a block diagram of a reusable lid and accompanying carrying case in accordance with an illustrative embodiment.

FIG. 2 is pictorial illustration of a reusable lid with the closure mechanism on the reusable lid shown in a closed position in accordance with an illustrative embodiment.

FIG. 3 is a pictorial illustration of a reusable lid with the closure mechanism on the reusable lid shown in an open position in accordance with an illustrative embodiment.

FIG. 4 is a cross-sectional view of the reusable lid shown in FIG. 2 in accordance with an illustrative embodiment.

FIG. 5 is another cross-sectional view of the reusable lid shown in FIG. 2 in accordance with an illustrative embodiment.

FIG. 6 is a cross-sectional view of the reusable lid shown in FIG. 2 located on top of a cross-sectional cup.

FIG. 7 is a pictorial illustration of the reusable lid shown in FIG. 2 within a carrying case in accordance with an illustrative embodiment.

FIG. 8 is a pictorial illustration of the carrying case in a closed position in accordance with an illustrative embodiment.

FIG. 9 is a cross sectional view of a reusable lid located within the carrying case shown in FIG. 7 and FIG. 8 in accordance with an illustrative embodiment.

FIG. 10 is a pictorial illustration of a reusable lid located within a clear carrying case in accordance with an illustrative embodiment.

FIG. 11 is a pictorial illustration of a reusable lid having an added gasket within a carrying case in accordance with an illustrative embodiment.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A. B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The present disclosure is generally drawn to various embodiments for a reusable lid that is configured for use with various sized cups with beverages sold and offered by various drinking establishments. Based on the recent issues and concerns with pollution and overuse of single use plastics, there is a great need to reduce the amount of disposal of plastic on a daily basis. In one or more non-limiting embodiments, a reusable lid is described herein that may be used to cover beverage cups, especially the disposable kind of beverage cups, instead of the usual single-use, disposable lids that are offered with such consumable and disposable beverage cups. In this regard, one may be able to contribute to the reduction of single use plastics and encourage reducing one's waste and carbon footprint on the environment.

The reusable lid as described herein in one or more non-limiting embodiments may be used to cover beverage cups sold or otherwise offered by their favorite or preferred drinking establishments. Thus, even if a user were to take their reusable lid to their preferred drinking establishment and purchase a particular sized beverage in a disposable cup from the drinking establishment, the reusable lid, as described herein in one or more non-limiting embodiments, is configured and able to fit over the disposable beverage cup. The reusable lid may securely and snugly fit over the beverage cup to protect the beverage inside the cup and to ensure that the beverage stays warm if the beverage is a hot drink. Further, the reusable lid may be made having a variety of decorative patterns, colors, and/or finishes. In one or more non-limiting embodiments, the reusable lid may include a cover mechanism to cover a drink hole in the lid to further ensure the user's beverage stays warm and is protected from unwanted elements falling into the cup.

Additionally, the present description further includes one or more non-limiting embodiments for a carrying case configured to hold the reusable lid to make it easier for the user to carry the reusable lid. The carrying case may include means for securing the carrying case to one's key chain or other convenient location. Further, the carrying case may be easily washable. Additional details for the one or more embodiments of the present invention are provided below with respect to the drawings that illustrate the one or more embodiments and their method of use.

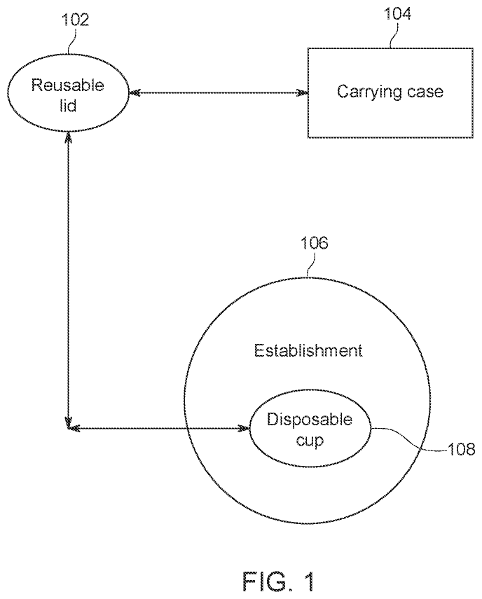

Turning now to FIG. 1, FIG. 1 is a block diagram of one or more components of the method and system described herein. In one or more non-limiting embodiments, lid 102 is a reusable lid. In other words, lid 102 is not a single use type lid, but rather is intended to be reused multiple times over and over again. “Reusable” may also imply that the lid 102 is not a single-use type of lid. Although at some point the reusable lid 102 may be recyclable depending on the material used to make the lid 102 whereby the materials may be recycled, in general, the reusable lid 102 is not intended to be disposed of after only one use. Rather, the reusable lid 102 is intended to be useable more than once and indeed, multiple times over a lengthy or extended period of time. By a lengthy or extended period of time, it is anticipated that a reusable lid 102 may be reused as many times as possible. Reusable lid 102 may be compared to examples of traditional drinkware and dinnerware that are often kept for many months or years until the item either breaks or is no longer usable due to wear and tear. The reusable lid 102 is designed to endure multiple uses to cover a particularly sized beverage cup offered by establishment 106 and designed to be sturdier than conventional single use plastic type lids that are typically made available to consumers when consumers purchase or otherwise receive a beverage cup from an establishment 106. Further, the reusable lid 102 may be durable in order to withstand multiple uses of being attached and removed to a disposable cup 108 and washed and dried when needed.

As noted above, the lid 102 is reusable so as to minimize pollution of single-use type lids and to conserve energy and resources that usually are dedicated to making single-use plastic lids and disposing of these single-use plastic lids. It is intended that reusable lid 102 may help in the efforts to conserve and preserve the environment by making conscientious efforts and decisions to reduce the use of single use plastics.

Lid 102 may be used to cover a cup, such as cup 108 that contains a beverage. Cup 108 may be sold by one or more establishments, including establishment 106, and may be intended to be a single-use, disposable type of cup. Establishment 106 may be any location that offers drinks and beverages, including hot or cold beverages. Such beverages may include, without limitation, coffee, tea, juice, sodas, or any type of beverage. Establishment 106 may be any type of shop, company, store, kiosk, or any type of location that includes beverages for sale or otherwise to customers. Examples of such establishments 106 may include, but are not limited to, Starbucks®, Dunkin Donuts®, Tim Hortons®, Peet's coffee®, or any other type of establishment anywhere in the world. Beverages offered by these establishments 106 may be warm or cold beverages without limitation thereto. Further, establishment 106 may sell a variety of food products and other items other than beverages.

Cup 108 may be obtained from and provided by establishment 106 in a variety of sizes. Most drinking establishments tend to provide their own cups in varying sizes and have a label for each size. For example, cups 108 sold at an establishment such as Starbucks® are sold in certain well-known sizes, including, tall, venti, grande, and trenta, to name a few of their size designations. Other companies may sell beverages as small, medium, large, x-large or have other designations for the sizes of their cups 108. It is noted that it may be preferable for cup 108 to be a standard round cup having a round top rim and an open cavity for filling cup 108 with a beverage. In other embodiments, cup 108 is not necessarily a round cup and lid 102 may be configured to fit such alternative shaped cups 108.

It is intended that reusable lid 102 may be provided for in all of the standard sized cups offered by the most well-known establishments 106 that offer beverages, including without limitation to, Starbucks®, Dunkin Donuts®, Tim Hortons®, Peet's coffee®, and many other locations. Accordingly, user is enabled to use their reusable lid 102 at their favorite beverage establishment 106 and is not prevented from buying their favorite drinks. Accordingly, cup 108 may be a disposable cup as offered by drinking establishment 106. In alternative embodiments, cup 108 may be a non-disposable cup that is usually sold as a durable plastic, glass, metal, or cup made from another type of sturdy, reusable material.

When purchasing their beverage from establishment 106, the user may let the salesperson know that they do not need one of their disposable, non-reusable lids and may choose to instead purchase the cup 108 with their beverage made by the employees of the drinking establishment 106 without a disposable, non-reusable lid. Upon receiving the beverage cup 108, the user may provide their own reusable lid 102 and cover cup 108 with reusable lid 102. Alternatively, or additionally, the user may provide the employee with their reusable lid 102 when first purchasing the beverage and the employee may cover the cup 108 with reusable lid 102 once the beverage has been made.

Accordingly, reusable lid 102 may be manufactured having a variety of sizes (e.g., small, medium, larger and/or tall, grande, venti, and trenta) that specifically match the size of the opening of a disposable cup 108 as sold by a specific establishment 106. Accordingly, the reusable lid 102 may have dimensions that equate to the standard sizes of most disposable cups 108 sold at most establishments 106. Accordingly, a user may purchase multiple sizes of the reusable lids 102 so that when the user wants to purchase different sized cups 108, the user has a reusable lid 102 configured to fit with the corresponding size of cup 108. Accordingly, the user may purchase a small size reusable lid 102 to match a small sized beverage that is provided by the establishment 106 in the small size disposable cup 108. Additionally, as part of the example, the user may also purchase a large sized reusable lid 102 that matches the large size disposable cup 108 sold by establishment 106 so that the user has the correct size reusable lid 102 to match the size of the disposable cup 108.

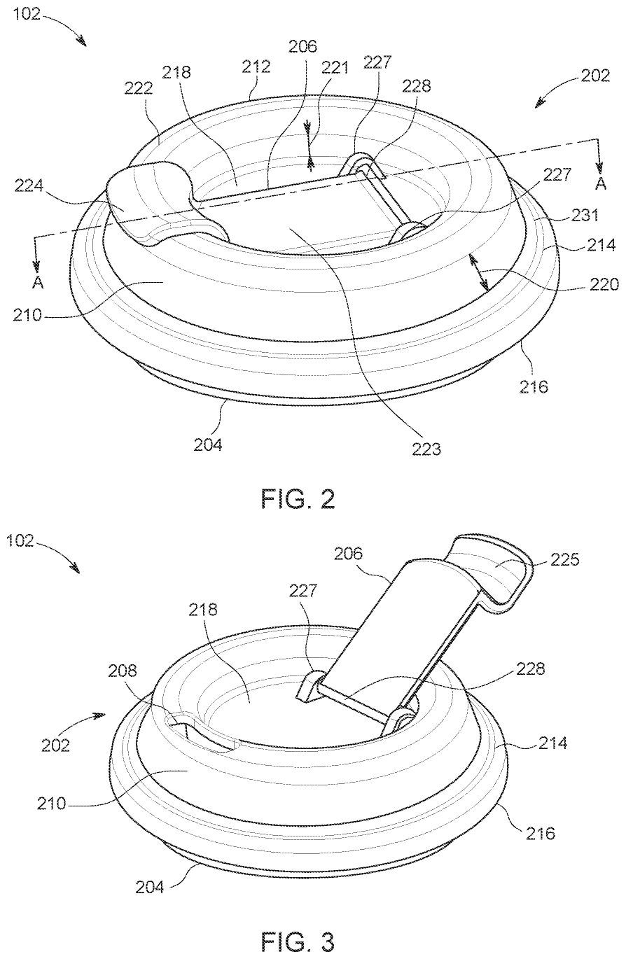

Reusable lid 102 may be made from any type of material known to one of ordinary skill in the art, including, without limitation, plastic, silicone, glass, metal, or any other type of material. In one or more embodiments, reusable lid 102 may be made of a combination of materials. As noted below with respect to FIGS. 2-5, one or more portions of lid 102 may be made from a plastic material and other portions of the reusable lid 102 may be made of a silicone type material (e.g., upper platform 202 as shown in FIG. 2 may be made from a sturdy, durable plastic or polymer material while lower platform 204 is made from a primarily silicone like material). It may also be preferable that the materials selected for manufacturing reusable lid 102 and carrying case 104 may be recyclable.

Because reusable lid 102 is intended to be reusable multiple times with multiple purchases (or other examples of procuring the cup 108, such as by gifting or bartering from the establishment 106), reusable lid 102 is easily washable by user. The term “reusable” as used herein means that the lid 102 is made of a sturdy material that is durable and designed to be used multiple times. Accordingly, the user may consume their beverage in cup 108 with lid 102 located on top of cup 108, and once the beverage has been consumed, the user may dispose of (e.g., recycle or throw away) cup 108 and keep lid 102 to wash for reuse again at a later point in time.

In one or more embodiments, the lid 102 may be stored when not in use on top of cup 108 in a carrying case, such as carrying case 104. Carrying case 104 is a carrying case configured to specifically fit the dimensions of lid 102. Accordingly, carrying case 104 may be made having a variety of sizes to fit the various sized lids 102 that the user may purchase for their preferred cups 108. In one or more non-limiting embodiments, carrying case 104 is made from plastic, but any other type of material may also be used, including silicone, metal, or any other type of material.

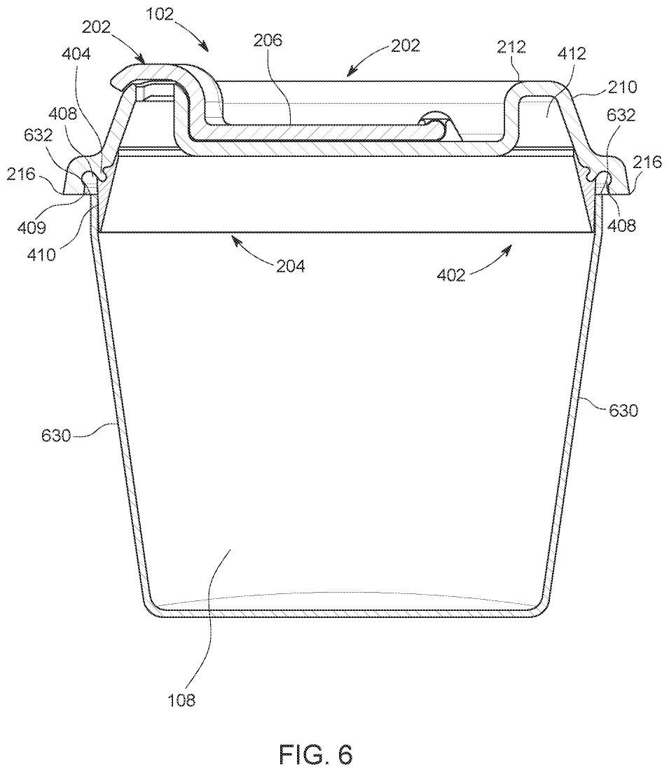

Further, carrying case 104 may include means for hanging or otherwise attaching carrying case 104 to one's keychain, phone, purse or bag, or any other location. Alternatively, carrying case 104 may contain lid 102 and may be stored in a user's car, purse, bag, or any other desired location. One or more non-limiting embodiments for carrying case 104 is further described below with respect to FIGS. 6-11. Carrying case 104 has a lid and a base and is configured to open and close for easy placement of reusable lid 102 within the carrying case 104.

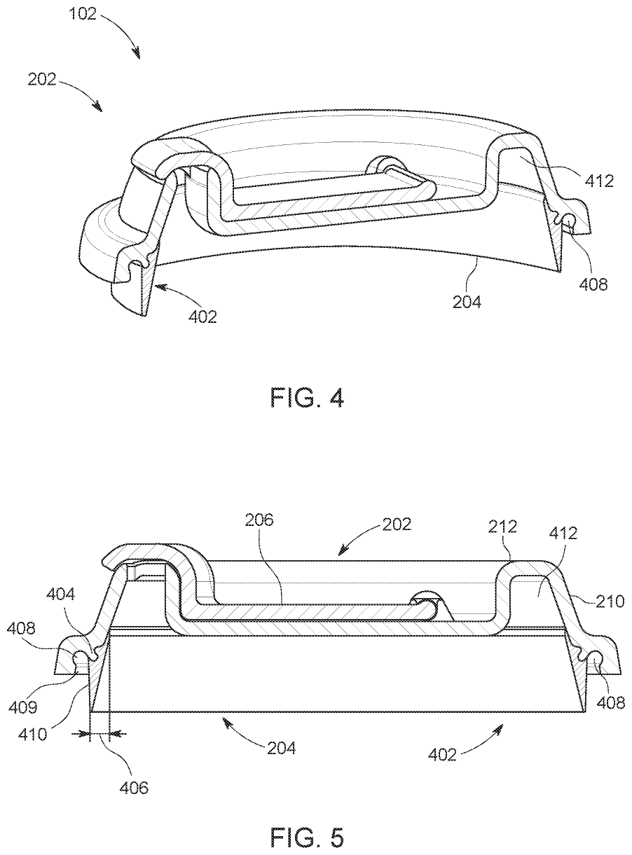

Turning to FIGS. 2 and 3, FIGS. 2 and 3 illustrate reusable lid 102 according to one or more non-limiting embodiments. Reusable lid 102 may include an upper platform 202 and a lower platform 204 (which may be more easily viewed in FIGS. 4 and 5). Further, reusable lid 102 may include a drink cover, such as drink cover 206 for covering drink opening 208. Drink opening 208 may be used for the user to have access and drink a beverage stored inside of a cup, such as cup 108, when cup 108 is attached or connected to reusable lid 102. Drink opening 208 may also act, in a sense, as a vent to help cool a hot beverage located inside an attached cup. In other embodiments, reusable lid 102 may include a separate smaller vent hole (not shown in Figures).

In FIG. 2, the drink cover 206 is shown in a closed position, whereas in FIG. 3, the drink cover 206 is shown in a raised, open position, whereby the drink opening 208 of reusable lid 102 is exposed. As shown in FIG. 3, in one non-limiting embodiment, the drink opening 208 has a curved, rounded open shape that is carved or otherwise made from the rounded shape of the top level 212 of the reusable lid 102, but in alternative embodiments, other non-rounded shapes are also contemplated for drink opening 208.

In one embodiment, upper platform 202 comprises the structural body of the top half or op portion of the reusable lid 102. The upper platform 202 may include, in one or more non-limiting embodiments, a generally circular wall 210, a raised top level 212 for access to the drink opening 208, a lower level 214, and an outer rim 216 that protrudes downwardly and away from the lower level 214 of the upper platform 202 of reusable lid 102.

Circular wall 210 may be a generally circular shaped wall portion of the upper platform 202. Circular wall 210 angles upwardly 220 at an inclined slope and joins with the top level 212 surface of the lid 102. The circular wall 210 may be continuously formed in one or more non-limiting embodiments and have an outer surface that angles 220 towards the lower level 214 of the lid 102. The inside top surfaces 221 of circular wall 210 may descend and join with a flat surface 218, as shown in FIGS. 2-3, on the top of the lid 102. The flat surface area 218 of the lid 102 may be encircled by the continuous circular wall 210 portion of the lid 102. In one or more non-limiting embodiments, the top level 212 may be rounded 222 to ensure a more ergonomic, pleasant drinking experience for users of reusable lid 102.

The flat surface area 218 may include a drink cover, such as drink cover 206. Drink cover 206, in one or more non-limiting embodiments, may be configured to cover the drink opening 208 (e.g., as shown in FIG. 2), and may be configured to lift up and stay open so that the user has access to think opening 208 (e.g., as shown in FIG. 3). Further, the drink cover 206 may be selectively opened and closed as needed to cover drink opening 208 to protect a beverage in an attached cup (e.g., cup 108) from unwanted elements falling in through drink opening 208 as well as to help ensure that the beverage stored with an attached cup does not cool too quickly if it is intended to be a hot beverage.

The components of drink cover 206 may include, in one or more non-limiting embodiments, an arm 223, a cover portion 224, and a hinge portion 228. As shown in FIGS. 2 and 3, in one or more non-limiting embodiments, drink cover 206 may be designed to hingedly swing up to open the think cover and to swing down or to be lowered down to lower the drink cover 206 to cover drink opening 208. At least two hinge connection elements 227 may be provided for on either side of the hinge point 228 of the arm portion 223 of the drink cover 206 in a non-limiting embodiment. The arm portion 223 of the drink cover 206 may be generally a wider, flat plane surface that extends from the hinge point 228 to the cover portion 224 of the drink cover 206. The cover portion 224 may be designed to have a curved body. The interior underside 225 (e.g., as shown in FIG. 3) of the cover portion 224 may be configured to fit the rounded shape 222 of the top level 212 of the lid 102 so as to properly cover the drink opening 208 and to fit the shape of the top level 212. In alternative embodiments, other shapes may be used in the design of cover portion 224 and/or the arm portion 223 of the drink cover 206.

As shown in FIGS. 2 and 3, the circular wall 210 may connect the top level 212 with the lower level 214 of the lid 102. The lower level 214 may encircle the circular wall 210 and may generally be a flat surface that extends outwardly away from the outer perimeter of the circular wall 210. The lower level 214, in one or more non-limiting embodiments, may include one or more grooves 231 to provide additional structural stability to the lid 102 when joined with a cup (e.g., cup 108). The lower level 214 may connect with the outer rim 216 of lid 102. The outer rim 216 may protrude and descend at an angle away from the lower level 214 of the lid 102, as shown in FIGS. 2 and 3.

Turning to FIG. 4 and FIG. 5, FIG. 4 and FIG. 5 are pictorial illustrations that show the lid 102 in a cross-sectional view taken at line A-A shown in FIG. 2, FIG. 4 and FIG. 5 may be helpful for illustrating more clearly the various underlying surfaces and components of reusable lid 102. In particular, FIG. 4 and FIG. 5 enable the user to more clearly see the lower platform 204 that extends beneath the upper platform 202 of reusable lid 102.

The lower platform 204 may include an interior wall 402 that extends along the inner perimeter of the upper platform 202. In other words, the interior wall 402 circumferentially extends around the inner perimeter of the upper platform 202 of lid 102. The interior wall 402 may be recessed inwardly from the outer edges of the outer rim 216 (e.g., as shown in FIG. 6) of the upper platform 202. The interior wall 402 may have a joint connection shown at 404 in FIG. 5 that joins both the bottom inner surface of the circular wall 210 and the bottom inner surface of the lower level 214 of the upper platform 202. In one or more non-limiting embodiments, the interior wall 402 has a width 406 (e.g., shown in FIG. 5) that increases as the interior wall extends from its outer surface to its inner surface. Accordingly, the bottom area of the interior wall 402 may be thinner than the top portion of the interior wall 402 of the lower platform 204. The interior wall 402, in one or more non-limiting embodiments, may function to fit within the inside of a cup (e.g., cup 108 shown in FIG. 1) when a user connects lid 102 to the top rim of a cup 108.

Accordingly, the interior wall 402 may act as a seal against the inside of the cup to assist in keeping the reusable lid 102 in place on the top of the cup and acts to ensure or to provide a tight fit to keep the reusable lid 102 in place when attached to the cup 108.

Continuing with FIG. 4, FIG. 4 shows that gap 408 is located between the inside surface 409 of the outer rim 216 and the outer surface 410 of the lower platform 204. Gap 408 may be carved or molded out of the underside of the outer rim 216 in one or more non-limiting embodiments. Gap 408 may extend circumferentially around the interior of the outer rim 216.

FIG. 4 and FIG. 5 show that the circular wall 210 may have an interior cavity 412 beneath the inside surface of the circular wall 210. The interior cavity 412 is defined by the elevated, inclining slope structure of the circular wall 210 which meets or joins with the top level 212 of the lid 102.

In one or more non-limiting embodiments, the upper platform 202 of reusable lid 102 may be made from a plastic material, while the lower platform 204, including interior wall 402, may be made from a silicone material.

FIG. 6 shows a cross-sectional view of the reusable lid 102 (taken along line A-A shown in FIG. 2) located over a cup 108. To use the reusable lid 102, a user or other party places the reusable lid 102 over the top rim 632 of the cup 108. The cup 108 may be a disposable, single use type of cup sold by establishment 108, as shown in FIG. 1. The user may have purchased the cup 108 with the desired beverage inside and is intending to cover the cup 108 with the reusable lid 102, rather than one of the single-use, disposable lids typically offered by establishment 106.

The outer rim 216, as shown in FIGS. 2 and 3, of the reusable lid 102 is configured to flex when the user pulls on its outer and inner surface and the p 408 circumferentially extending beneath the outer rim 216 is where the top rim 632 of the cup 108 is configured to fit. This may cause the lower platform 204 to be inserted into the cavity of the cup 108 and to rest against the interior sides of the wall surfaces 630 of the cup 108.

As shown in FIG. 6, once the reusable lid 102 is placed on top of the cup 108, the outer rim 216 of the lid 102 may grip against the outside rim 632 of the cup 108 while the lower platform 204 may grip against the inside walls 630 of the cup 108, thus helping to ensure a tighter, better fit on the cup. This may be particularly beneficial, because if the cup is a disposable, single use type of cup sold by an establishment (e.g., establishment 106), these cups may not be very sturdy, and it is desirable to ensure for the user that reusable lid 102 may snugly and securely fit over a cup obtained from such an establishment 106. Once reusable lid 102 is located on the cup 108, the user may selectively open and close the drink cover 206 by raising and lowering the drink cover 206 to access the drink opening 208 and to drink his or her beverage located within the cup 108.

The reusable lid 102 may be configured to have a specific size and set of dimensions such that the reusable lid 102 fits over a specific cup size for a specific cup 108 as provided by or offered by establishment 106 along with the beverage located inside of the cup 108 (including disposable cups). In particular, the width of the reusable lid 102 may be configured to fit over the top opening of the cup 108. Further, the outer rim 216 of the cup 108 may be sized to fit over the top rim 632 of the cup 108. The outer rim 216 of the cup 108 may fit just over the top rim 632 of the cup 108 with a snug fit or minimal flexibility in order for the outer rim 216 of the cup 108 to stay securely attached to the top rim 632 of the cup 108.

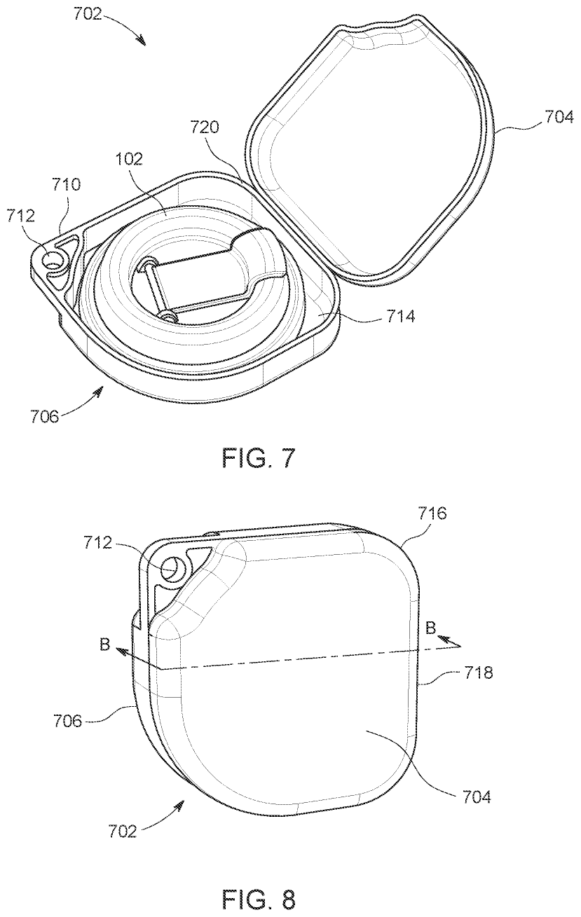

Turning to FIG. 7, FIG. 7 shows a pictorial illustration of a carrying case configured to hold or store the reusable lid 102 when not in use on a cup. FIG. 8 also provides a pictorial illustration of the carrying case shown in FIG. 7. Carrying case 702 is configured to open and close as needed. Carrying case 702 is designed to accommodate and hold reusable lid 102 as described above with respect to FIGS. 1-6. Carrying case 702 may function as and be in accordance with carrying case 104 as described above with respect to FIG. 1.

In one or more non-limiting embodiments, carrying case 702 may include a lid 704 and a base 706. The lid 704 and base 706 may be hingedly connected 720 in one or more non-limiting embodiments. In one or more non-limiting embodiment, the lid 704 and base 706 may be attached or together so as to have the hinged connection 720. Alternatively, other means may be used to connect the carrying case lid 704 and base 706, including without limitation, using fasteners of any kind or adhesives or other means of attachment known in the art.

Carrying case 702 may be designed to fit the outer perimeter of reusable lid 102 and may include one or more rounded edges 716 and one or more straight edges 718 in one or more non-limiting embodiments.

Carrying case 702 may further include a tab 710 that protrudes from both the lid 704 and the base 706. In some embodiments, as shown in FIG. 7, tab 710 may protrude from just the lid 704 or base 706 so that carrying case 702 does not have to be removed from a ring, bag, etc. in order to open and close carrying case 702. Further, as shown in FIGS. 7-10, the tab 710 may be triangular shaped and may include a circular hole or opening 712. In one or more non-limiting embodiments, it may be useful for carrying case 702 to include the opening 712 such that the user can attach a string or lanyard (not shown) or attach the carrying case 702 to his or her keychain (or other tool) so that it is more convenient to transport the carrying case 702. It should be easily feasible for the user to store carrying case 702 in his or her purse, bag, car, or any location desired.

The user may selectively press down on the top surface of tab 710 in order to open carrying case 702. When a user desires to close the lid 704 over the base 706, the user may press on the outside surface of the carrying case lid 702, which will cause the lid 704 to connect with the base 706 and to the tab 710. The tab 710 may connect or be adjoined to the base 706 in one or more non-limiting embodiments.

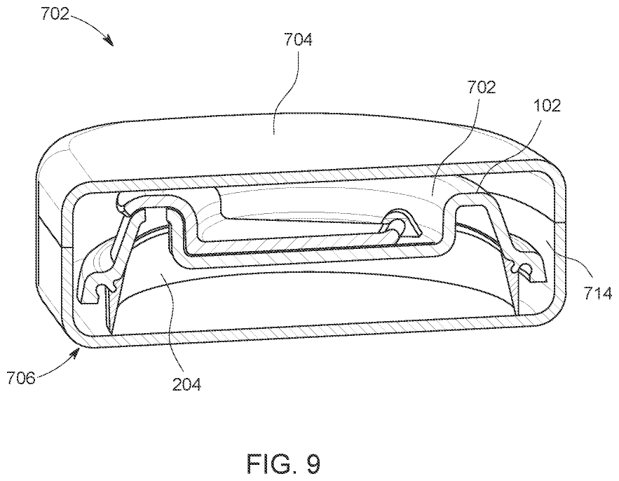

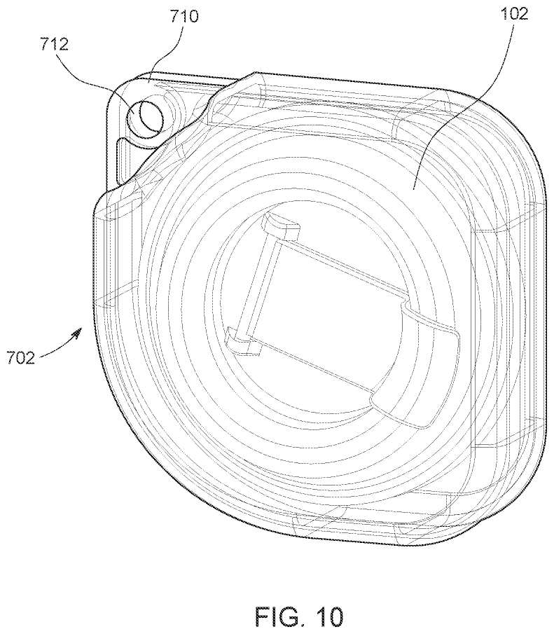

FIG. 9 is a cross sectional view of carrying case 702 taken along line B-B as shown in FIG. 8. As shown in FIG. 9 (and in FIG. 7), reusable lid 102 can snugly and easily fit within the interior space 714 of carrying case 702. A user may find it useful to carry carrying case 702 with reusable lid 102 stored inside of the carrying case 702 when the reusable lid 102 is not in use attached to a cup (e.g., cup 108) so as to keep reusable lid 102 clean. Additionally, once the reusable lid 102 has been used, the user may want to store reusable lid 102 within the carrying case 702 until the user can clean reusable lid 102. Both the carrying case 702 and reusable lid 102, including all of their components, are designed to be easily washable and cleanable such that the user may regularly utilize reusable lid 102 and carrying case 702 on multiple occasions.

FIGS. 7-9 display a non-limiting embodiment of carrying case 702 being opaque or not transparent. FIG. 10 shows an alternative embodiment of carrying case 702 which may he clear and transparent so that the user is able to see through the body of carrying case 702 and the reusable lid 102 located within the interior space 714 of the carrying case 702 is visible from the outside of the carrying case 702. Accordingly, various embodiments of carrying case 702 may be designed to be opaque (e.g., as shown in FIGS. 7-9), while other embodiments of carrying case 702 may be manufactured being clear and transparent (e.g., as shown in FIG. 10). Any material may be used to manufacture carrying case 702, including without limitation, plastics, silicone, metal, or a combination thereof. The carrying case 702 may also be provided in different sizes to accommodate different sized reusable lids 102 that may be used to cover cups 108 of different sizes (e.g., tall, grande, venti or small, medium, large). Usefully, carrying case 702 may be helpful for a user to carry around the reusable lid 102 so that the user does not forget to take the reusable lid 102 with him or her when needed to cover a cup 108, including a disposable cup 108 that is bought or otherwise obtained from an establishment 106. Further, the carrying case 702 can store the reusable lid 102, whether the reusable lid 102 is clean or dirty (e.g., such as after being used to cover a disposable cup 108).

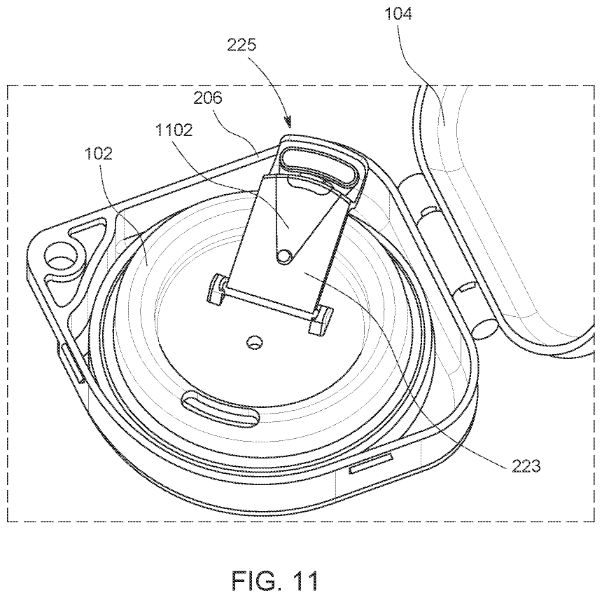

In addition to the above, FIG. 11 shows an example of reusable lid 102 with a gasket 1102 located on the underside 225 of drink cover 206. The reusable lid 102 may include gasket 1102 in order to keep any liquid from leaking out of the drink cover 206 or through the reusable lid 102 when the reusable lid 102 is placed over a cup 108. Further, the gasket 1102 may assist in preventing air from entering the underlying cup 108 and makes the lid 102 airtight.

Accordingly, the present description provides for various embodiments for a reusable lid that may be useful for a user who wants to reduce pollution and make conscious choices to reduce the use of disposable, single use plastics as much as possible in their daily lives. While there are conventionally available drink containers that a user may carry that are reusable, it may be easier for users to carry a reusable lid 102 rather than having to carry a reusable drink container, such as a drink thermos or mug with a lid.

In this manner, the user is able to environmentally conscious and reduce his or her carbon footprint while consuming their preferred beverage by limiting the use of single use plastics when he or she uses reusable lid 102 to cover their favorite beverage sold or otherwise offered at their preferred drinking establishment 106. Multiple other advantages and benefits may be provided by the non-limiting embodiments provided herein for the reusable lid 102 and carrying case 702.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A reusable lid to cover a top opening of a cup, the reusable lid comprising:
an upper platform, wherein the upper platform comprises:
a top level, wherein the top level includes a drink opening;
a drink cover configured to cover the drink opening, wherein the drink cover is configured to selectively cover and provide access to the drink opening;
an outer rim, wherein the outer rim protrudes downwardly; and
a lower platform, wherein the lower platform comprises:
an interior wall located on the underside of the reusable lid, wherein the interior wall is a circular wall that is continuously formed and descends downwardly from the upper platform.

2. The reusable lid of claim 1, wherein the reusable lid is configured to be positioned over a top rim of a cup, wherein the outer rim of the upper platform of the reusable lid is configured to fit over the top rim of the cup, and wherein the interior wall located on the underside of the lower platform is positioned within an interior of the cup and makes contact with interior walls of the cup.

3. The reusable lid of claim 2, wherein the interior wall acts to provide a tight fit between the reusable lid and the cup.

4. The reusable lid of claim 1, wherein the upper platform further comprises:
a circular wall, wherein the circular wall is continuous and encircles a flat surface located beneath the top level, wherein the circular wall angles downwardly towards the flat surface.

5. The reusable lid of claim 4, wherein the drink cover is positioned on the flat surface located beneath the top level and encircled by the continuously formed, circular wall.

6. The reusable lid of claim 1, wherein the reusable lid can be positioned on top of a disposable cup.

7. The reusable lid of claim 6, wherein the disposable cup is provided by an establishment.

8. The reusable lid of claim 1, wherein the reusable lid is adapted to fit in a portable carrying case.

9. The reusable lid of claim 8, wherein the portable carrying case comprises:
a lid; and
a base, wherein the reusable lid is configured to fit within an interior space of the portable carrying case.

10. The reusable lid of claim 9, wherein the portable carrying case further comprises a tab, wherein the tab is connected to the base, wherein the tab is configured to be selectively pressed to open the lid located on top of the base.

11. A system for a reusable lid and carrying case, wherein the system comprises:
the reusable lid, wherein the reusable lid comprises:
an upper platform, wherein the upper platform comprises:
a top level, wherein the top level includes a drink opening;
a circular wall, wherein the circular wall is continuous and encircles a flat surface located beneath the top level, wherein the circular wall angles downwardly towards the flat surface;
an outer rim, wherein the outer rim protrudes downwardly from the upper platform;
a drink cover configured to cover the drink opening, wherein the drink cover is positioned on the flat surface located beneath the top level and encircled by the continuously formed, circular wall, wherein the drink cover is hingedly connected to the flat surface and is configured to selectively cover and provide access to the drink opening;
a lower platform, wherein the lower platform comprises:
an interior wall located on the underside of the upper platform, wherein the interior wall is a circular wall that is continuously formed and descends downwardly from an underside of the upper platform,
wherein the reusable lid is configured to be positioned over a top rim of a cup, wherein the outer rim of the upper platform fits over the top rim of the cup, and the interior wall of the reusable lid fits within an interior of the cup, wherein the interior wall acts to provide a tight fit between the reusable lid and the cup; and
a carrying case, wherein the carrying case is configured to contain the reusable lid, the carrying case further comprising:
a lid; and
a base, wherein the reusable lid is configured to fit within an interior space of the carrying case.

12. The system of claim 11, wherein the carrying case further comprises a tab, wherein the tab is connected to base, wherein the tab is configured to be selectively pressed to open the lid located on top of the base.

13. The system of claim 11, wherein the carving case is attachable to another item by hooking or otherwise securing the carrying case onto the other item.

14. A method for using a reusable lid, the method comprising:
providing a reusable lid adapted for use to fit over a top rim and top opening of a disposable cup, wherein the disposable cup is provided by an establishment,
wherein the reusable lid is sized and is dimensioned to fit a specific size and set of dimensions associated with the disposable cup,
wherein the reusable lid is reusable multiple times and over an extended period of time and can cover any disposable cup having the specific size and the set of dimensions that corresponds to the size of the reusable lid.

15. The method of claim 14, further comprising, positioning an outer rim of the reusable lid over the top rim of the disposable cup.

16. The method of claim 14, further comprising, positioning the reusable lid such that an interior wall that extends continuously below an upper platform of the reusable lid is located inside of an interior of the disposable cup, wherein the interior wall of the reusable lid contacts and abuts against inner walls of the interior of the disposable cup.

17. The method of claim 16, wherein the interior wall acts to provide a tight fit between the reusable lid and the cup.

18. The method of claim 14, further comprising, providing a portable carrying case configured to retain the reusable lid within an interior cavity of the portable carrying case.

19. The method of claim 18, further comprising, providing the portable carrying case that is configured to be hooked onto or otherwise attached to another portable item.

20. The method of claim 19, wherein the another portable item comprises a set of keys, a cell phone, a purse, or a wallet.
